(19) United States
(12) Patent Application Publication
(10) Pub. No.: US 2025/0245165 A1
(43) Pub. Date: Jul. 31, 2025

(54) REDUCED OVERHEAD STORAGE BLOAT PREVENTION IN EDGE CACHING SYSTEMS

(71) Applicant: Palo Alto Networks, Inc., Santa Clara, CA (US)

(72) Inventors: Badrinath Natarajan, San Jose, CA (US); Rosarin Jolly Roy Antonyraj, Santa Clara, CA (US)

(21) Appl. No.: 18/429,361

(22) Filed: Jan. 31, 2024

(51) Int. Cl. G06F 12/0891

(52) U.S. Cl. CPC G06F 12/0891; G06F 2212/604

(57) ABSTRACT

A cache manager tracks activity of cached resources and evicts those that are deemed inactive. The cache manager maintains a timestamp in cache memory for each cached resource and maintains an update threshold that indicates how often the last access time of a resource should be updated in storage. Upon receiving a request for a cached resource, the cache manager determines if a difference between the current time and the timestamp maintained for the resource in memory exceeds the threshold. If so, the cache manager updates the last access time of the resource in storage and updates the corresponding timestamp in cache memory. Additionally, a background process periodically iterates through cached resources maintained in storage and evaluates their last access times based on an inactivity threshold. Cached resources that have not been accessed within the inactivity threshold as determined based on the last access times are evicted from storage.

### BACKGROUND

The disclosure generally relates to information retrieval (e.g., CPC subclass G06F 16/00) and to storing data temporarily at an intermediate stage, such as caching (e.g., CPC subclass H04L 67/658).

Edge caching is a technique employed in networks having servers distributed across a geographic area, such as content delivery networks (CDNs) or software-defined wide area networks (SD-WANs), where resources (also referred to as “assets”) are stored closer to clients in caching servers near the network's edge rather than in a single central location. When used in reference to caching, time-to-live (TTL) refers to the amount of time that cached resources are to be maintained in the cache. Until the TTL expires for a resource, requests for the resource will be served from the cache. Once the TTL expires for a resource, the existing resource will be evicted (i.e., released) from the cache, and the next request for the resource will be served from its origin server. Cache eviction, also referred to as purging, is the practice of clearing resources from a cache. Cache eviction helps to ensure “freshness” of cached resources in that a resource can be refreshed (i.e., evicted and retrieved from the origin again) in the cache periodically.

### BRIEF DESCRIPTION OF THE DRAWINGS

Embodiments of the disclosure may be better understood by referencing the accompanying drawings.

FIG. 1 is a conceptual diagram of tracking activity of resources cached by a cache server with reduced overhead.

FIG. 2 is a conceptual diagram of identifying and evicting cached resources that are inactive.

FIG. 3 is a flowchart of example operations for selectively updating last access times maintained for cached resources in cache server storage.

FIG. 4 is a flowchart of example operations for identifying and evicting inactive resources maintained by a cache server.

FIG. 5 depicts an example computer system with a cached resource activity tracking manager and a cache eviction manager.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Cache bloat refers to the situation where cached resources that are infrequently accessed (i.e., retrieved and/or updated) are maintained by a cache server, thus occupying storage space that cannot readily be used by other resources that are accessed more frequently. A cache freshness manager (“the cache manager”) disclosed herein tracks “freshness” of cached resources so that resources that are infrequently accessed can be evicted from the cache server. To do so, the cache manager maintains a timestamp in cache memory for each cached resource indicating the last time that the access time for the resource was updated in the cache server's storage (the “access timestamp”). The access timestamp maintained for a resource in cache memory and the corresponding last access time in storage has an initial value of the time when the resource was first cached. The cache manager also maintains an update threshold, which is represented in terms of time and indicates how often the last access time associated with a resource should be updated in storage. Each time a cached resource is accessed based on receipt of a request indicating the resource, the cache manager determines if a difference between the current time and the access timestamp maintained for the resource in cache memory exceeds the update threshold (i.e., if current time-access timestamp>update threshold). If so, the cache manager updates the last access time of the resource in storage and also updates the corresponding access timestamp in cache memory. Storage writes to update the last access time of a cached resource are thus limited by the update threshold, which can substantially reduce storage writes performed for frequently accessed resources that have been cached because the last access timestamp of a frequently accessed resource need not be updated on each access of the resource. Maintaining access timestamps in cache memory provides for rapid comparisons as cached resources are accessed.

Additionally, a cache eviction manager that executes on the cache server as a background process maintains an inactivity threshold that is also represented in terms of time. The cache eviction manager periodically iterates through cached resources maintained in storage of the cache server and evaluates their last access times based on the inactivity threshold. The last access times read from storage are utilized to determine whether a cached resource can be considered inactive since these timestamps are persisted in the event of a system restart, upgrade, or a similar event, which may not be the case for the access timestamps maintained in cache memory. If the result of the evaluation indicates that the cached resource's last access was beyond the inactivity threshold as determined based on the last access time (i.e., if current time-last access timestamp>inactivity threshold), the cache eviction manager evicts the cached resource from storage of the cache server. This eviction criterion that is based on the last access time and inactivity threshold has precedence over TTL values of cached resources, so cached resources that are infrequently accessed can be evicted prior to expiration of their TTL if the eviction criterion is satisfied.

### Example Illustrations

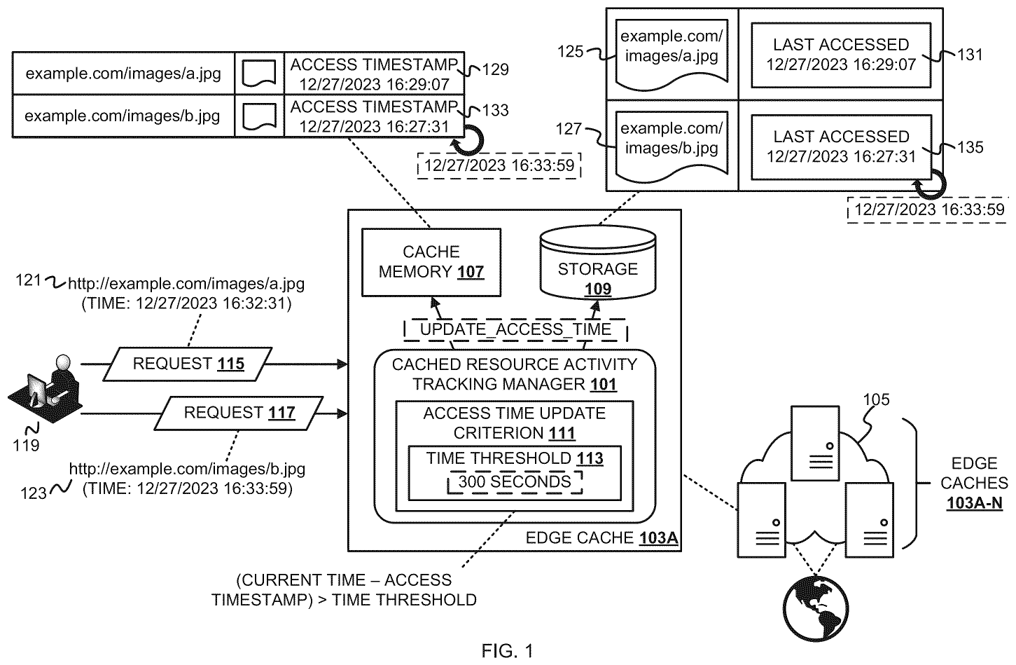

FIG. 1 is a conceptual diagram of tracking activity of resources cached by a cache server with reduced overhead. Edge caches 103A-N, which are physical or virtual (e.g., implemented with virtual machines) edge servers with caching capabilities, are geographically distributed throughout a network 105. While not depicted in FIG. 1 for simplicity, each of the edge caches 103A-N can cache resources stored in a respective data center of the network 105. For instance, the network 105 may be an SD-WAN, where the edge caches 103A-N are instantiated at respective branch offices, or a CDN for which the edge caches 103A-N cache content. An instance of a cached resource activity tracking manager (“activity tracking manager”) 101 executes on each of the edge caches 103A-N. This example depicts the activity tracking manager 101 executing on an edge cache 103A in greater detail.

The activity tracking manager 101 maintains or has access to cache memory 107 and storage 109 of the edge cache 103A. The cache memory 107 may be implemented as a hash table or other data structure that maps keys to values, where Uniform Resource Locators (URLs) (and optionally any variant information) are used to compute keys, and information about each cached resource, including a location of the cached resource in storage 109 of the edge cache 103A, are stored as values that can be retrieved via the respective keys. This example assumes that URLs are used as cache keys in the cache memory 107 in this example for simplicity. The storage 109 of the edge cache 103A comprises disk storage, network file storage, network-attached storage, or similar. In this example, the edge cache 103A has cached a resource 125 with the URL “example.com/images/a.jpg” and a resource 127 with the URL “example.com/images/b.jpg”, each of which can be retrieved to fulfill corresponding requests based on lookups in cache memory 107 and storage 109. While protocols have been omitted from the URLs indicated in the cache memory 107 and storage 109 for simplicity, in implementations, URLs of cached resources that are stored in cache memory 107 and storage 109 can indicate any protocol used for retrieval of resources, such as Hypertext Transfer Protocol (HTTP) or HTTP Secure (HTTPS).

As part of performing cache lookups and fulfilling requests, the activity tracking manager 101 also evaluates access timestamps associated with cached resources in cache memory 107 to determine whether the last access time, or stored timestamp of last access, maintained for the resource in storage 109 should be updated. The activity tracking manager 101 associates access timestamps with each entry in cache memory 107, each of which corresponds to a resource and indicates the time of the most recent update to that resource's last access time in storage 109. An access timestamp may have an initial value of the time that the resource is cached. Rather than updating the last access time of a cached resource in storage 109 each time the resource is accessed (e.g., requested and retrieved to fulfill the request), the activity tracking manager 101 performs storage writes to update last access timestamps for resources stored therein periodically according to an access time update criterion (“criterion”) 111. While the last access times maintained in storage 109 may not necessarily reflect the actual time a corresponding resource was last accessed, reducing updates to last access times in storage 109 reduces overhead for the edge cache 103A. The activity tracking manager 101 uses access timestamps maintained in cache memory 107 for evaluation based on the criterion 111.

The criterion 111 in this example indicates that if a difference between the current time and the access time of a cached resource maintained in cache memory 107 exceeds a time threshold 113, then the last access time of the resource maintained in storage 109 should be updated. The time threshold 113 can be a preconfigured value of the activity tracking manager 101 and has a value corresponding to a minimum elapsed time between updates to a resource's last access time in storage. To illustrate, referring to this example where the time threshold 113 has a value of 300 seconds, the criterion 111 indicates that a cached resource's last access time should be updated in storage 109 if a difference between the current time and the resource's access time maintained in cache memory 107 is greater than 300 seconds. The time threshold 113 is represented in seconds in this example but can be represented in minutes, hours, etc. in implementations. The activity tracking manager 101 uses the access timestamps maintained in cache memory 107 to track when cached resources' last access times were most recently updated and to inform whether the last access time of a resource should be updated based on receiving a request for the resource.

In this example, the resource 125 has an access timestamp 129 maintained in cache memory 107 indicating that the last update to its last access time 131 in storage 109 was on Dec. 27, 2023 at 16:29:07, and the last access time 131 in storage 109 also indicates the time Dec. 27, 2023 at 16:29:07. The resource 127 has an access timestamp 133 maintained in cache memory 107 indicating that the last update to its last access time 135 in storage 109 was on Dec. 27, 2023 at 16:27:31, and the last access time 131 in storage 109 also indicates the time Dec. 27, 2023 at 16:27:31. Timestamps and last access times may be represented according to Coordinated Universal Time (UTC) timestamps or epoch timestamps. Generally, as is the case in this example, access timestamps maintained in cache memory 107 will have the same values as the corresponding last access times in storage 109 unless a system restart, software update, etc. has taken place that results in deletion of the access timestamps maintained in cache memory 107.

This example depicts a client 119 that issues two requests received by the edge cache 103: a request 115 for a resource identified by a URL 121 (http://example.com/images/a.jpg), and a request 117 for a resource identified by a URL 123 (http://example.com/images/b.jpg). The requests 115, 117 are HTTP requests in this example. The request 115 is assumed to precede the request 117 chronologically. Subsequent description refers to the flow of operations performed based on the edge cache 103A receiving the request 115 first and subsequently receiving the request 117.

On receipt of the request 115 by the edge cache 103A, the activity tracking manager 101 identifies the URL 121 included therein. The activity tracking manager 101 performs a lookup for the URL 121 in cache memory 107, which yields a cache hit and prompts a second lookup for the corresponding resource in storage 109 (i.e., the resource 125) at the location identified in the corresponding entry of cache memory 107. The activity tracking manager 101 can then fulfil the request 115 with the resource 125 retrieved from storage 109. The activity tracking manager 101 also evaluates the access timestamp 129 maintained for the resource 125 in cache memory 107 based on the current time and the criterion 111. The current time used for the purpose of the evaluation may be the time associated with evaluation of the request 115 or a time indicated in the request 115 in cases where times are included in requests by clients and are in a consistent format across clients (e.g., as request metadata or in a request header). This example assumes that the time associated with the request 115 and thus the current time is Dec. 27, 2023 at 16:32:31. As dictated by the criterion 111, the activity tracking manager 101 determines a difference between the current time and the access timestamp 129 and evaluates the difference based on the time threshold 113 to determine if the criterion 111 is satisfied and the last access time 131 for the resource 125 should thus be updated in storage 109. In this example, the difference between the current time and the access timestamp 129 is less than the time threshold 113 of 300 seconds. The activity tracking manager 101 thus does not update the last access time 131 for the resource 125 in storage, and the current values of the access timestamp 129 and last access time 131 are maintained.

Later, on receipt of the request 117 by the edge cache 103, the activity tracking manager 101 identifies the URL 123 included therein. The activity tracking manager 101 performs a lookup for the URL 123 in cache memory 107, which yields a cache hit and prompts a second lookup for the corresponding resource in storage 109 (i.e., the resource 127) at the location identified in the corresponding entry of cache memory 107. The activity tracking manager 101 can then fulfil the request 117 with the resource 127 retrieved from storage 109. The activity tracking manager 101 also evaluates the access timestamp 133 maintained for the resource 127 in cache memory 107 based on the current time and the criterion 111. This example assumes that the time associated with the request 117 and thus the current time is Dec. 27, 2023 at 16:33:59. As dictated by the criterion 111, the activity tracking manager 101 determines a difference between the current time and the access timestamp 133 and evaluates the difference based on the time threshold 113 to determine if the criterion 111 is satisfied and the last access time 131 for the resource 127 should thus be updated in storage 109. In this example, the difference between the current time and the access timestamp 133 exceeds the time threshold 113 of 300 seconds. The activity tracking manager 101 thus updates the last access time 135 for the resource 127 in storage.

The activity tracking manager 101 can issue a system call to update the last access time 135 associated with the resource 127 in storage 109. The system call should at least indicate the current time, or Dec. 27, 2023 at 16:33:59 in this example, and the resource 127. The activity tracking manager 101 also updates the access timestamp 133 maintained for the resource 127 in cache memory 107 with the current time to reflect that the corresponding last access time in storage 109 was updated at a time given by the current time. Updating the access timestamp 133 in cache memory 107 can be achieved through a memory write to the corresponding entry that identifies the resource 127. As illustrated by this example, the activity tracking manager 101 updates last access times of resources in storage 109 for which the criterion 111 is satisfied as informed by the corresponding access timestamps maintained in cache memory 107, while last access times in storage are not updated for resources for which the criterion 111 is not satisfied, thus conserving system calls issued for storage writes.

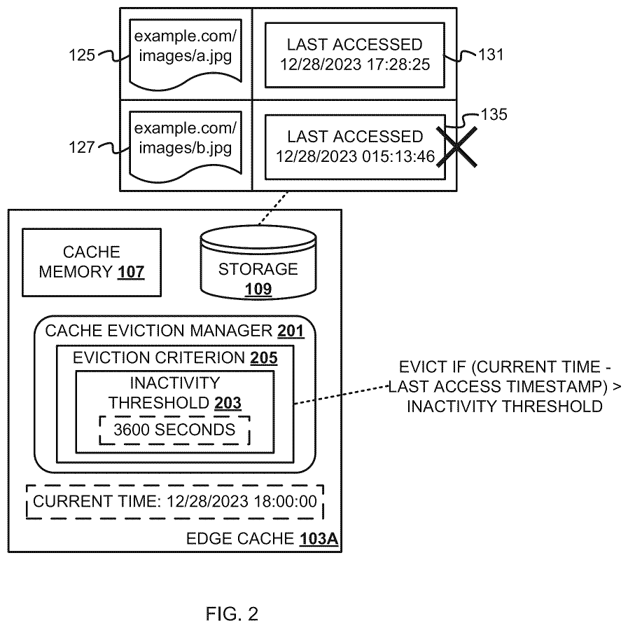

FIG. 2 is a conceptual diagram of identifying and evicting cached resources that are inactive. FIG. 2 depicts a cache eviction manager 201 that executes on the edge cache 103A (and others of the edge caches 103A-N depicted in FIG. 1). The cache eviction manager 201 executes as a background process (e.g., a daemon) that periodically evicts select resources from the edge cache 103A, which removes those resources from the cache memory 107 and storage 109. The cache eviction manager 201 can execute concurrently with the activity tracking manager 101 of FIG. 1. In other words, the cache eviction manager 201 can evict inactive resources from a cache server while the activity tracking manager 101 manages access time updates for cached resources as described above. The edge cache 103A can launch the cache eviction manager 201 when selective cache eviction is triggered. For instance, selective cache eviction can be performed according to a schedule or at fixed time increments (e.g., every three hours, daily, etc.). Selective cache eviction can thus be triggered if a designated time since the last cache eviction has elapsed.

The cache eviction manager 201 iterates through resources maintained in storage 109 of the edge cache 103A and evaluates their last access times based on an eviction criterion 205. The eviction criterion 205 indicates an inactivity threshold 203 and specifies that resources should be evicted if their stored timestamp indicating their last access time is beyond the inactivity threshold 203, which has a value of 3600 seconds (i.e., one hour) in this example. The inactivity threshold 203 is represented in seconds but can be represented in minutes, hours, etc. in implementations. This example represents the eviction criterion 205 as being satisfied if a difference between the current time and the last access timestamp of a resource exceeds the inactivity threshold 203. A resource should therefore be evicted from the edge cache 103A (i.e., removed from cache memory 107 and storage 109) if its last access time maintained in storage 209 indicates that it has not been accessed within the last hour. This example assumes a current time of Dec. 28, 2023 at 18:00:00, which may be the time determined by the cache eviction manager 201 at the start of cache eviction operations. Resources having last access times maintained in storage 109 that are prior to Dec. 28, 2023 at 17:00:00 should thus be evicted in accordance with the eviction criterion 205.

The cache eviction manager 201 determines whether the resource 125 is active and should remain cached based on the eviction criterion 205. The last access time 131 maintained in storage 109 for the resource 125 has a current value of Dec. 28, 2023 at 17:28:25. The cache eviction manager 201 determines a difference between these times, evaluates the difference against the inactivity threshold 203, and determines that the difference is below the threshold and thus does not satisfy the eviction criterion 205. Since the last access time 131 indicates that the resource 125 has been accessed within the time window set forth by the inactivity threshold 203 (i.e., within the last hour), the cache eviction manager 201 maintains the resource 125 in storage 109.

The cache eviction manager 201 also determines whether the resource 127 is active and should remain cached based on the eviction criterion 205. The last access time 135 maintained in storage 109 for the resource 127 has a current value of Dec. 28, 2023 at 15:13:46. The cache eviction manager 201 determines a difference between these times, evaluates the difference against the inactivity threshold 203, and determines that the difference exceeds the threshold and thus satisfies the eviction criterion 205. Since the resource 127 has not been accessed within the time window set forth by the inactivity threshold 203, the resource 127 is deemed inactive and evicted from storage 109. The cache eviction manager 201 thus deletes the resource 127 from storage 109, thus freeing up storage space of the edge cache 103A for other, more active resources.

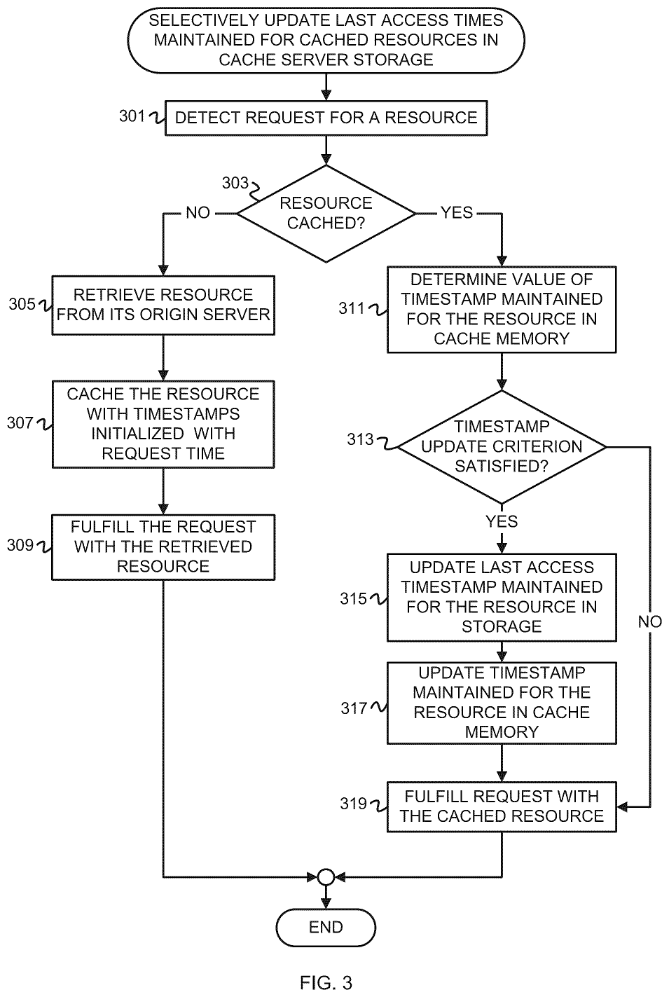

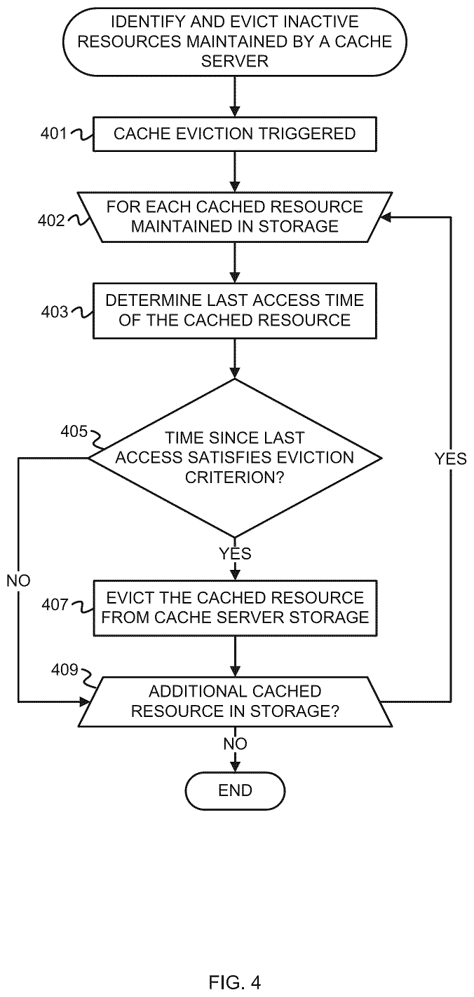

FIGS. 3 and 4 are flowcharts of example operations. The example operations are described with reference to a cached resource activity tracking manager (hereinafter “activity tracking manager”) and a cache eviction manager for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for selectively updating last access times maintained for cached resources in cache server storage. The example operations are described with reference to the activity tracking manager. The example operations assume that the cache server maintains a last access timestamp for each resource in storage and that the activity tracking manager can update last access timestamps via system calls. The example operations also assume that the cache server also maintains timestamps entries in cache memory that indicate a time of the most recent update to the corresponding last access timestamp in storage. Generally, the last access timestamps maintained in cache memory will match the timestamps maintained in storage for the respective resources, though the timestamps maintained in storage will be persisted between system shutdowns, restarts, etc. and thus may differ from the timestamps maintained in memory in case of such events.

At block 301, the activity tracking manager detects a request for a resource. Subsequent operations assume that the request is valid, or that the request identifies an existing resource, is sent by a requestor that is authorized to communicate over the network to which the cache server is connected, etc. The request may be an HTTP(S) request that identifies the resource (e.g., via its URL).

At block 303, the activity tracking manager determines if the resource has been cached. The activity tracking manager computes a cache key based on the request (e.g., based on one or more identified header fields based on which cache keys are computed) and performs a lookup in cache memory using the cache key. If the resource has not been cached, the lookup will result in a cache miss, and operations continue at block 305. If the resource has been cached, the lookup will yield a cache hit, and operations continue at block 311.

At block 305, the activity tracking manager retrieves the resource from its origin server. The activity tracking manager obtains the resource from its origin via a request sent to its origin server (e.g., an HTTP request).

At block 307, the activity tracking manager caches the resource with its timestamps initialized with the time of the request. The activity tracking manager updates cache memory and storage with data/metadata of the resource to cache the resource. The activity tracking manager also initializes a last access timestamp maintained for the resource in storage and a timestamp associated with the resource in cache memory with the time of the request. The activity tracking manager may determine the time of the request based on a current time maintained by the cache server, based on a header of the request (e.g., in a header field indicating time), etc. The activity tracking manager initializes the timestamp for the resource's entry in cache memory via a memory write by which the activity tracking manager associates the timestamp with the cache memory entry (e.g., as a label or tag, as an attribute in the corresponding entry, etc.). The activity tracking manager can initialize the last access timestamp of the resource in storage via a system call. In other examples, initialization of the last access timestamp may be default behavior for the cache server, which can vary among operating systems.

At block 309, the activity tracking manager fulfills the request with the retrieved resource. The activity tracking manager responds to the request with the retrieved resource, such as by forwarding the retrieved HTTP response to the requestor.

At block 311, the activity tracking manager determines a value of a timestamp associated with the resource in cache memory. The activity tracking manager reads the value of the timestamp maintained in association with the resource's cache entry (e.g., as a label or tag, in an attribute stored in the cache entry, etc.). This timestamp indicates a time when the last access timestamp of the corresponding resource in storage was last updated.

At block 313, the activity tracking manager determines if a timestamp update criterion is satisfied. As an example, the timestamp update criterion is satisfied if the difference between the current time and the time indicated by timestamp read from cache memory exceeds a threshold. The threshold indicates how often last access timestamps should be updated for cached resources in storage. In other words, regardless of how many times a cached resource is accessed (i.e., read from the cache memory/storage to fulfill a request), its last access timestamp should be updated in storage every N seconds, minutes, etc. rather than on each access to reduce storage writes. The threshold may be a preconfigured value of the activity tracking manager. The activity tracking manager determines the current time and determines if a difference between the current time and the time indicated by the timestamp exceeds the threshold indicated by the timestamp update criterion and thus satisfies the criterion. The current time for the purpose of the evaluation may be a current time maintained by the cache server, a time determined based on a header of the request, etc. If the timestamp update criterion is satisfied, operations continue at block 315. If the timestamp update criterion is not satisfied, operations continue at block 319.

At block 315, the activity tracking manager updates the last access timestamp maintained for the resource in storage. The activity tracking manager updates the last access timestamp associated with the resource in storage with the current time determined for the evaluation based on the timestamp update criterion, which may be the time associated with or indicated by the request. Updating the last access timestamp can be achieved through a system call that indicates the resource and the time with which to update the resource's last access timestamp.

At block 317, the activity tracking manager updates timestamp maintained for the resource in cache memory. The activity tracking manager updates the timestamp associated with the resource in cache memory with the current time determined for the evaluation based on the timestamp update criterion, which may be the time associated with or indicated by the request.

At block 319, the activity tracking manager fulfills the request with the cached resource. The activity tracking manager performs a lookup(s) for the cached resource (e.g., with a first in-memory lookup and a second lookup in storage) and generates a response to the request that comprises the resource retrieved as a result of the lookup(s).

FIG. 4 is a flowchart of example operations for identifying and evicting inactive resources maintained by a cache server. The example operations assume that the cache eviction manager can access storage of the cache server.

At block 401, cache eviction is triggered. Cache eviction may be triggered based on a schedule, based on an elapsed time since the last cache eviction, etc.

At block 402, the cache eviction manager begins iterating over cached resources maintained in storage of the cache server. Iteration over cached resources during eviction operations is performed in storage because the last access times maintained therein should have been persisted across events that may have resulted in removal of the corresponding access timestamps from cache memory (e.g., system restarts and/or upgrades).

At block 403, the cache eviction manager determines the last access time of the cached resource. The cache eviction manager determines the last access time associated with the cached resource in storage. The cache eviction manager can determine the last access time associated with the cached resource in storage by executing a command or script, via a system call, etc.

At block 405, the cache eviction manager determines if the time since the last access satisfies an eviction criterion. The cache eviction manager has been configured with a criterion for evicting cached resources that can be considered inactive. Cached resources are considered inactive if they have not been accessed in the last N days, hours, etc. The criterion can indicate a threshold or time window accordingly. The cache eviction manager evaluates the timestamp indicating last access time of the resource based on the threshold or time window to determine whether its last access satisfies the criterion for eviction due to inactivity of the cached resource. For instance, the cache eviction manager can determine if a difference between the current time and the last access timestamp exceeds the threshold and the resource thus has not been accessed in the last N days, hours, etc. designated by the criterion and satisfies the criterion for eviction. If the time since the last access satisfies the criterion for eviction, operations continue at block 407. If the time since the last access does not satisfy the criterion for eviction, operations continue at block 409.

At block 407, the cache eviction manager evicts the cached resource from the cache server storage. Eviction of the cached resource includes removing (i.e., deleting) the resource from storage to free up the space in storage that was allocated for the resource. The cache eviction manager can remove the resource from storage via a system call, by executing a command or script, etc.

At block 409, the cache eviction manager determines if there is another cached resource in storage. If there is another cached resource in storage, operations continue at block 402. If not, operations are complete.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, referring to FIG. 3, the operations depicted in blocks 307 and 309 can be performed in parallel or concurrently. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

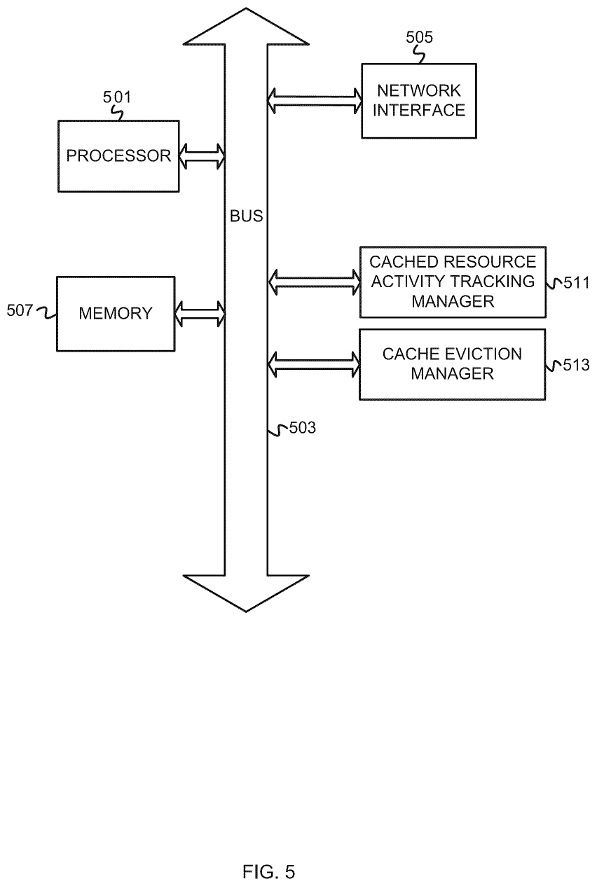

FIG. 5 depicts an example computer system with a cached resource activity tracking manager and a cache eviction manager. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes cached resource activity tracking manager 511 and cache eviction manager 513. The cached resource activity tracking manager 511 selectively updates last access times for cached resources in storage of a cache server on which it executes based on tracking access times of the cached resources. The cache eviction manager 513 evicts resources from cache server storage that are determined to be inactive based on ongoing tracking and selective updating of last access times of cached resources maintained in storage. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
maintaining, by a cache server, a plurality of timestamps for a plurality of cached resources in cache memory,
wherein each of the plurality of timestamps corresponding to one of the plurality of cached resources indicates when a last access time of the cached resource maintained in storage of the cache server was updated;
detecting a request for a first cached resource of the plurality of cached resources;
determining if an update criterion is satisfied for a last access time of the first cached resource based, at least in part, on a first timestamp of the plurality of timestamps corresponding to the first cached resource, wherein the update criterion is a criterion for updating last access times of cached resources in storage of the cache server; and
based on determining that the update criterion is satisfied for the last access time of the first cached resource, updating the last access time maintained for the first cached resource in storage.

2. The method of claim 1 further comprising evicting those of the plurality of cached resources that satisfy an eviction criterion from storage of the cache server based, at least in part, on a plurality of last access times maintained in storage for the plurality of cached resources.

3. The method of claim 2, wherein evicting those of the plurality of cached resources that satisfy the eviction criterion from storage of the cache server comprises, for each cached resource of the plurality of cached resources and corresponding last access time of the plurality of last access times,
determining if a difference between a current time and the last access time exceeds an inactivity threshold; and
based on determining that the difference between the current time and the last access time exceeds the inactivity threshold, evicting the cached resource from storage of the cache server.

4. The method of claim 2, wherein evicting those of the plurality of cached resources that satisfy the eviction criterion is performed periodically.

5. The method of claim 1, wherein determining if the update criterion is satisfied for the last access time for the first cached resource comprises determining if a difference between a current time and the first timestamp exceeds a threshold.

6. The method of claim 5, wherein updating the last access time maintained for the first cached resource in storage comprises updating the last access time with the current time.

7. The method of claim 6 further comprising updating the first timestamp with the current time based on updating the last access time maintained for the first cached resource with the current time.

8. The method of claim 1, wherein updating the last access time maintained for the first cached resource in storage comprises making a system call to update the last access time maintained for the first cached resource in storage.

9. One or more non-transitory machine-readable media having program code stored thereon, the program code comprising instructions to:
maintain, by a cache server, a plurality of timestamps for a plurality of cached resources in cache memory, wherein each of the plurality of timestamps corresponding to one of the plurality of cached resources indicates when a last access time of the cached resource maintained in storage of the cache server was updated;
detect a request for a first cached resource of the plurality of cached resources;
evaluate a first timestamp of the plurality of timestamps corresponding to the first cached resource based on a criterion to determine whether to update a last access time of the first cached resource in storage;
determine, based on the evaluation, that the criterion is satisfied; and
update the last access time maintained for the first cached resource in storage.

10. The non-transitory machine-readable media of claim 9, wherein the program code further comprises instructions to periodically evict any of the plurality of cached resources that satisfy an eviction criterion from storage of the cache server based, at least in part, on a plurality of last access times maintained in storage for the plurality of cached resources.

11. The non-transitory machine-readable media of claim 10, wherein the instructions to evict those of the plurality of cached resources that satisfy the eviction criterion from storage of the cache server comprises, for each cached resource of the plurality of cached resources and corresponding last access time of the plurality of last access times,
determine whether a difference between a current time and the last access time exceeds an inactivity threshold; and
based on a determination that the difference between the current time and the last access time exceeds the inactivity threshold, evict the cached resource from the cache server,
wherein the instructions to evict the cached resource from the cache server comprise instructions to remove the cached resource from storage.

12. The non-transitory machine-readable media of claim 9, wherein the instructions to evaluate the first timestamp based on the criterion comprise instructions to determine whether a difference between a current time and the first timestamp exceeds a threshold, and wherein the instructions to determine that the criterion is satisfied comprise instructions to determine that the difference between the current time and the first timestamp exceeds the threshold.

13. The non-transitory machine-readable media of claim 9, wherein the program code further comprises instructions to update the first timestamp maintained for the first cached resource in cache memory based on the update of the last access time maintained for the first cached resource in storage.

14. An edge server comprising:
a processor; and
a machine-readable medium having instructions stored thereon that are executable by the processor to cause the edge server to,
detect a request for a first cached resource of a plurality of cached resources, wherein each of the plurality of cached resources has a corresponding one of a plurality of timestamps associated therewith in cache memory,
wherein the plurality of timestamps maintained in cache memory indicate a time that a last access time of the corresponding one of the plurality of cached resources was updated in storage;
determine if an update criterion is satisfied for a last access time of the first cached resource based, at least in part, on a first timestamp of the plurality of timestamps corresponding to the first cached resource, wherein the update criterion is a criterion for updating last access times of cached resources in storage; and
based on a determination that the update criterion is satisfied for the last access time of the first cached resource, update the last access time maintained for the first cached resource in storage.

15. The edge server of claim 14 further comprising instructions executable by the processor to cause the edge server to periodically evict any of the plurality of cached resources that satisfy an eviction criterion from storage based, at least in part, on a plurality of last access times maintained in storage for the plurality of cached resources.

16. The edge server of claim 15, wherein the instructions executable by the processor to cause the edge server to evict any of the plurality of cached resources that satisfy the eviction criterion comprise instructions executable by the processor to cause the edge server to, for each cached resource of the plurality of cached resources and corresponding last access time of the plurality of last access times,
determine if a difference between a current time and the last access time exceeds an inactivity threshold; and
based on a determination that the difference between the current time and the last access time exceeds the inactivity threshold, evict the cached resource from storage of the edge server.

17. The edge server of claim 14,
wherein the instructions executable by the processor to cause the edge server to determine if the update criterion is satisfied comprise instructions executable by the processor to cause the edge server to determine if a difference between a current time and the first timestamp exceeds a threshold, and
wherein the instructions executable by the processor to cause the edge server to determine that the update criterion is satisfied comprise the instructions executable by the processor to cause the edge server to determine that the difference between the current time and the first timestamp exceeds the threshold.

18. The edge server of claim 14, wherein the instructions executable by the processor to cause the edge server to update the last access time maintained for the first cached resource in storage comprise instructions executable by the processor to cause the edge server to make a system call to update the last access time maintained for the first cached resource in storage.

19. The edge server of claim 14 further comprising instructions executable by the processor to cause the edge server to update the first timestamp based on updating the last access time maintained for the first cached resource in storage.

20. The edge server of claim 19,
wherein the instructions executable by the processor to cause the edge server to update the last access time maintained for the first cached resource in storage comprise instructions to update the last access time with a current time, and
wherein the instructions executable by the processor to cause the edge server to update the first timestamp comprise instructions executable by the processor to cause the edge server to update the first timestamp with the current time.
